(19) United States
(12) Patent Application Publication
(10) Pub. No.: US 2011/0249058 A1
(43) Pub. Date: Oct. 13, 2011

(54) INK SET AND IMAGE FORMING METHOD

(75) Inventors: Naoya SHIBATA, Ashigarakami-gun (JP); Jun Matsumoto, Ashigarakami-gun (JP)

(73) Assignee: FUJIFILM Corporation, Tokyo (JP)

(21) Appl. No.: 13/084,184

(22) Filed: Apr. 11, 2011

(30) Foreign Application Priority Data
Apr. 12, 2010 (JP) 2010-091479
Apr. 5, 2011 (JP) 2011-083921

(51) Int. Cl. B41J 2/015; C09D 11/10

(52) U.S. Cl. 347/21; 524/114

(57) ABSTRACT

There is provided an ink set which suppresses adhesion and deposition of aggregates, has excellent removability of adhered deposits (maintenance properties), and suppresses the occurrence of image defects such as white streaks, so that the formation of high resolution images can be realized. The ink set has an aqueous ink composition which contains a self-dispersing pigment having a carboxyl group at the surface of the pigment, a water-soluble organic solvent, a phosphoric acid ester, and water; and a treatment liquid which contains a cationic polymer and which agglomerates the self-dispersing pigment when brought into contact with the aqueous ink composition.

### BACKGROUND OF THE INVENTION

1. Field of the Invention

The present invention relates to an ink set and an image forming method using the same.

2. Description of the Related Art

As recording media for ink-jet recording, various recording media have been studied and techniques capable of forming high quality images are in demand. Further, for inks, color material such as a pigment have been investigated as ink materials from the viewpoint of water resistance and lightfastness, and the like.

However, upon performing recording on ordinary paper, sufficient performance may not be obtained in some cases, in terms of color development density, fixability, resolution and the like. Particularly, an instance of enhancing the inkjet recording speed may be mentioned, and there has been a demand for recording suitability in the case of performing high-speed recording in a single pass system which is capable of recording by a single-step head operation.

As a method for achieving high fixability and the prevention of bleeding when images are formed on various recording media, there has been proposed a method of using two kinds of liquids, such as a first liquid containing resin-coated pigment particles and a second liquid containing a liquid composition capable of aggregating a pigment (see, for example, JP2003-266916A).

On the other hand, self-dispersing pigments are often selected from the viewpoints of simplicity of the production processes and cost. Examples of the self-dispersing pigment that is conventionally well-known include pigments of a type having sulfonic acid groups at the surface. However, in view of improving the film quality and enhancing scratch resistance, it is preferable to select pigments of a type having carboxyl groups at the surface (see, for example, JP2009-166387A).

### SUMMARY OF THE INVENTION

However, in the methods described above, defective ejection directionality occurs in the process of image formation, which is caused by the generation of mist occurring during the droplet ejection of the first liquid and the second liquid, and consequent adhesion and drying of aggregates that are formed by a mixture of the two liquids in the vicinity of the head. The aggregates may not be removed depending on the liquid that is newly ejected, and the adhered deposits (that is, maintenance properties) are also not sufficiently removable. Therefore, there has been a problem that defects such as white streaks occur in the recorded images.

The invention was made under such circumstances, and it is an object of the invention to provide an ink set which suppresses adhesion and deposition of aggregates, has excellent removability of adhered deposits (maintenance properties), and suppresses the occurrence of image defects such as white streaks, so that the formation of high resolution images can be realized.

Furthermore, it is another object of the invention to provide an image forming method which suppresses adhesion and deposition of aggregates, has excellent removability of adhered deposits (maintenance properties), and suppresses the occurrence of image defects such as white streaks, so that the formation of high resolution images can be realized.

The term “maintenance” according to the invention includes retention and sustainment (maintenance) of the inkjet head that ejects an ink composition for inkjet recording and the ejection performance of the inkjet head in an expected state or a state close thereto, as well as cleaning of the recording head to thereby maintain the recording head in a more satisfactory state. A maintenance liquid includes a cleaning liquid for cleaning an ink composition as well.

In order to achieve the objects described above, according to an aspect of the invention, there is provided an ink set including an aqueous ink composition which contains a self-dispersing pigment having a carboxyl group at the surface of the pigment, a water-soluble organic solvent, a phosphoric acid ester, and water; and a treatment liquid which contains a cationic polymer and which agglomerates the self-dispersing pigment when brought into contact with the aqueous ink composition.

According to the aspect of the invention, the phosphoric acid ester may be anionic, and preferably has 4 moles or more of ethylene oxide per mole of the ester molecule.

According to the aspect of the invention, the cationic polymer preferably includes at least one polyguanidine.

According to the aspect of the invention, the aqueous ink composition preferably further contains resin particles.

According to the aspect of the invention, the pigment that constitutes the self-dispersing pigment preferably includes a magenta pigment.

According to the aspect of the invention, the aqueous ink composition preferably includes at least one selected from a black ink composition, a cyan ink composition, a magenta ink composition and a yellow ink composition.

In order to achieve the objects described above, according to another aspect of the invention, there is provided an image forming method which includes an ink applying step of using an ink set which has an aqueous ink composition containing a self-dispersing pigment having a carboxyl group at the surface of the pigment, a water-soluble organic solvent, a phosphoric acid ester and water, and a treatment liquid which contains a cationic polymer and which agglomerates the self-dispersing pigment when brought into contact with the aqueous ink composition, applying the aqueous ink composition in the ink set on a recording medium by an inkjet method; and a treatment liquid applying step of applying the treatment liquid in the ink set on the recording medium.

According to the aspect of the invention, it is preferable to form an image on the recording medium by using an inkjet apparatus having an inkjet head that ejects the aqueous ink composition and an ink jet head that ejects the treatment liquid.

According to the aspects of the invention, there may be provided an ink set which suppresses adhesion and deposition of aggregates, has excellent removability of adhered deposits (maintenance properties), and suppresses the occurrence of image defects such as white streaks, so that the formation of high resolution images can be realized.

According to the aspects of the invention, there may be provided an image forming method which suppresses adhesion and deposition of aggregates, has excellent removability of adhered deposits (maintenance properties), and suppresses the occurrence of image defects such as white streaks, so that the formation of high resolution images can be realized.

### DESCRIPTION OF THE PREFERRED EMBODIMENTS

<Ink Set>

The ink set of the invention includes an aqueous ink composition containing a self-dispersing pigment having a carboxyl group at the surface of the pigment, a water-soluble organic solvent, a phosphoric acid ester, and water; and a treatment liquid which contains a cationic polymer and which agglomerates the self-dispersing pigment when brought into contact with the aqueous ink composition.

The ink set of the invention particularly contains a cationic polymer in the treatment liquid, and also particularly contains a self-dispersing pigment having a carboxyl group and a phosphoric acid ester in the aqueous ink composition, and therefore, the deposits formed by adhesion and drying of the aggregates that result from mixing of the two liquids in the vicinity of the head due to the generation of mist that occurs during the droplet ejection of the aqueous ink composition and the treatment liquid, can be easily removed. Furthermore, the occurrence of defects such as white streaks in the images, which are caused by deposits and the like, can be suppressed.

Furthermore, the ink set of the invention is preferably an ink set in which the aqueous ink composition according to the invention includes at least one selected from a black ink composition, a cyan ink composition, a magenta ink composition and a yellow ink composition, from the viewpoint that the occurrence of defects such as white streaks in the images may be markedly suppressed.

The ink set of the invention is preferably used in an image forming method employing an inkjet system, but can also be used for the applications of general writing instruments, recorders and pen plotters.

[Aqueous ink composition] The aqueous ink composition according to the invention (hereinafter, also referred to as “ink composition”) is constituted to include a self-dispersing pigment having a carboxyl group at the surface of the pigment, a water-soluble organic solvent, a phosphoric acid ester and water, and is preferably constituted to further include resin particles. The aqueous ink composition is constituted to further include other components, as necessary.

The ink composition according to the invention is used not only in the formation of monochromic images but also in the formation of polychromic images (for example, full-color images), and images can be formed by selecting one color or two or more colors as desired. In the case of forming full-color images, the ink composition can be used as a magenta color ink, a cyan color ink, or a yellow color ink. Furthermore, the ink composition may also be used as a black color ink so as to adjust the color tone.

Furthermore, the ink composition can also be used as an ink composition of the color tone of red (R), green (G), blue (B) or white (W) in addition to the color tones of yellow (Y), magenta (M) and cyan (C), or as an ink composition of a so-called special color in the field of printing.

Ink compositions of the various colors described above can be prepared by altering the color of the colorant (for example, a self-dispersing pigment) as desired.

(Self-Dispersing Pigment)

The ink composition according to the invention contains, as a colorant (hereinafter, also referred to as a color material), at least one self-dispersing pigment having a carboxyl group at the surface of the pigment. Particularly, since the self-dispersing pigment has a carboxyl group at the surface of the pigment, the film quality is improved. Furthermore, since a phosphoric acid ester that will be described later is used in combination, there can be provided effects of suppressing adhesion and deposition of aggregates, having excellent removability of adhered deposits (maintenance properties), and suppressing the occurrence of image defects such as white streaks, so that the formation of high resolution images can be realized.

In addition to the self-dispersing pigment, a pigment, a dye, colorant particles and the like may also be used to the extent of not impairing the effects of the present invention.

The self-dispersing pigment according to the invention is a pigment having a carboxyl group at the surface of the pigment, that is, a pigment which exhibits at least any of water-dispersibility and water-solubility in the absence of a dispersant for pigment dispersion, by attaching a carboxyl group (hereinafter, also referred to as a “dispersibility imparting group”) to the surface of the pigment either directly or indirectly via another atomic group or the like. More specifically, mainly, a magenta pigment, carbon black or the like is hydrophilized by subjecting the pigment surface to an oxidation treatment, so that the simple substance of the pigment becomes dispersible in water.

Examples of the other atomic group include a linear or unsubstituted alkylene group having 1 to 12 carbon atoms, a substituted or unsubstituted phenylene group, and a substituted or unsubstituted naphthylene group. Here, examples of the substituents which may be bonded to the phenylene group or the naphthylene group include a linear or branched alkyl group having 1 to 6 carbon atoms.

An ink containing the self-dispersing pigment as a colorant has no need to contain a dispersant that is usually incorporated to disperse the pigment. Therefore, there is hardly any foaming occurring due to the decrease in defoamability caused by dispersants, and it is easy to prepare an ink having excellent ejection stability.

Examples of the dispersibility imparting group that is attached to the surface of the self-dispersing pigment include —COOH and salts thereof (for example, quaternary ammonium salts). These groups are attached by subjecting a pigment to a physical treatment or a chemical treatment, and thereby bonding (grafting) a dispersibility imparting group or an active species having a dispersibility imparting group to the surface of the pigment.

Examples of the physical treatment include a vacuum plasma treatment.

Furthermore, examples of the chemical treatment include a wet oxidation method of oxidizing the pigment surface using an oxidizing agent in water, and a method of bonding p-aminobenzoic acid to the pigment surface and thereby bonding a carboxyl group to the pigment surface via a phenylene group.

For example, a preferred example of the self-dispersing pigment may be a pigment which is surface treated by an oxidation treatment using a hypohalogenous acid and/or a hypohalogenite, or by an oxidation treatment using ozone.

More specifically, an example of a method of introducing —COONa to the carbon black surface may be a method of subjecting commercially available carbon black to an oxidation treatment using sodium hypochlorite.

Furthermore, an example of a method of bonding an —Ar—COONa group (wherein Ar represents an arylene group) to the carbon black surface may be a method of subjecting a NH₂—Ar—COONa group to the action of nitrous acid to obtain a diazonium salt, and bonding the diazonium salt to the carbon black surface. However, the invention is not intended to be limited to these.

Commercially available products may also be used as the self-dispersing pigment, and specific examples include CAB-O-JET 300 (trade name; manufactured by Cabot Corp.).

The pigment that constitutes the self-dispersing pigment used as a colorant in the invention is not particularly limited, and can be appropriately selected according to the purposes. The pigment may be, for example, any of an organic pigment and an inorganic pigment.

Examples of the organic pigment include an azo pigment, a polycyclic pigment, a dye chelate, a nitro pigment, a nitroso pigment, and aniline black. Among these, an azo pigment, a polycyclic pigment and the like are more preferable.

Examples of the azo pigment include an azo lake, an insoluble azo pigment, a condensed azo pigment, and a chelate azo pigment. Examples of the polycyclic pigment include a phthalocyanine pigment, a perylene pigment, a perinone pigment, an anthraquinone pigment, a quinacridone pigment, a dioxazine pigment, an indigo pigment, a thioindigo pigment, an isoindolinone pigment, and a quinophthalone pigment. Examples of the dye chelate include a basic dye chelate and an acidic dye chelate.

Examples of the inorganic pigment include titanium oxide, iron oxide, calcium carbonate, barium sulfate, aluminum hydroxide, barium yellow, cadmium red, chrome yellow, and carbon black. Among these, carbon black is particularly preferable.

Examples of the carbon black include those produced according to known methods such as a contact method, a furnace method, and a thermal method.

There are no particular limitations on the pigment that constitutes the self-dispersing pigment, but the pigment preferably includes at least one kind of magenta pigment, from the viewpoint of ink stability.

The self-dispersing pigments may be used individually, or plural kinds may be selected and used in combination.

The content of the self-dispersing pigment in the ink composition is preferably an amount of 1% to 25% by mass, and more preferably an amount of 5% to 20% by mass, relative to the total mass of the ink composition, from the viewpoints of color density, particle shape, ink stability and ejection reliability.

(Phosphoric Acid Ester)

The ink composition of the invention contains at least one phosphoric acid ester. When the ink composition contains a phosphoric acid ester, the adhesion and deposition of aggregates that result from mixing of the two liquids in the vicinity of the head due to the generation of mist that occurs during droplet ejection of the ink composition and the treatment liquid according to an inkjet method, is suppressed, while the removability of adhered deposits (maintenance properties) is improved.

Particularly, when the ink composition containing a self-dispersing pigment having a carboxyl group at the surface of the pigment, further contains a phosphoric acid ester, not only the white streaks in the images caused by the generation of mist occurring during droplet ejection, but also the scratch resistance of images are markedly improved.

The mechanism of this effect is suspected to be as follows.

That is, the strength of the ink film that is formed using a self-dispersing pigment is decreased, and due to the generation of mist that occurs during droplet ejection of the ink composition containing a self-dispersing pigment having a carboxyl group at the pigment surface and the treatment liquid containing a cationic polymer, the adhesion and deposition of aggregates that results from mixing of the two liquids become severe. However, when an ink composition contains a self-dispersing pigment having a carboxyl group at the pigment surface and a phosphoric acid ester, the adhesion and deposition of aggregates to the head are suppressed, and the removal of aggregates can be easily achieved by the interaction between the aggregates and the phosphoric acid ester, so that white streaks in the image are consequently suppressed.

The phosphoric acid ester is distributed as a phosphoric acid ester surfactant, and includes anionic, nonionic, zwitterionic and amphoteric phosphoric acid esters, or mixtures thereof.

According to the invention, the term “amphoteric” means that the molecule contains both a cationic group and an anionic group. When an amphoteric phosphoric acid ester surfactant is present in an acidic environment, the amphoteric phosphoric acid ester surfactant has a cationic group, and in a basic environment, the amphoteric phosphoric acid ester surfactant has an anionic group. At a neutral pH, the amphoteric phosphoric acid ester surfactant has a cationic group and an anionic group, and thus has a charge that is neutral in overall.

Furthermore, according to the invention, the term “zwitterionic” means that the surfactant contains both an anionic group and a cationic group, and thereby has a neutral charge. The zwitterionic phosphoric acid ester surfactant is different from an amphoteric surfactant in that the charge of the zwitterionic phosphoric acid ester surfactant does not exhibit sensitivity to changes in pH.

Examples of the phosphoric acid ester include, but are not particularly limited to, the commercially available surfactants under the trade names Emphos (registered trademark), DeSophos (trademark), Hostaphat (registered trademark), ESI-Terge (registered trademark), Emulgen (registered trademark), Crodafos (trademark), Dephotrope (trademark) and DePHOS (trademark), available from Witco Corp. (Middlebury, Conn., USA), Clariant GmbH (Frankfurt, Germany), Cook Composites and Polymers Co. (Kansas City, Mo., USA), Kao Specialties Americas LLC (High Point, N.C., USA), Croda Inc. (Parsippany, N.J., USA), and DeForest Enterprises, Inc. (Boca Raton, Fla., USA).

There are no particular limitations on the anionic, nonionic and amphoteric phosphoric acid esters that can be used, and examples include Crodafos (trademark) N-3Acid, Emphos (registered trademark) 9NP, Emphos (registered trademark) CS121, Emphos (registered trademark) CS131, Emphos (registered trademark) CS141, Emphos (registered trademark) CS1361, Hostaphat (registered trademark) LPKN, ESI-Terge (registered trademark) 320, ESI-Terge (registered trademark) 330, DePhos (trademark) 8028, Emulgen (registered trademark) BL-2PK, DeSophos (trademark) 4P, DeSophos (trademark) 6DNP, DeSophos (trademark) 6MPNa, DeSophos (trademark) 6NPNa, DeSophos (trademark) 8DNP, DeSophos (trademark) 9NP, DeSophos (trademark) 10TP, DeSophos (trademark) 14DNP, DeSophos (trademark) 30NP, and Dephotrope (trademark) CAS-MF.

Examples of the phosphoric acid ester include oleth-3 phosphate, nonylphenol ethoxylate phosphoric acid ester, salts of nonylphenol ethoxylate phosphoric acid ester, organic phosphates, aliphatic phosphoric acid esters, phosphorylated nonylphenoxy polyethoxyethanol, and salts of ethylhexanol ethoxylated phosphoric acid ester (“2EH-2EO”).

Examples of the phosphoric acid ester also include Dephotrope (trademark) CAS-MF, Emphos (registered trademark) 9NP, Emphos (registered trademark) CS121, Emphos (registered trademark) CS131, Emphos (registered trademark) CS141, Emphos (registered trademark) CS1361, ESI-Terge (registered trademark) 320, and ESI-Terge (registered trademark) 330.

When the phosphoric acid ester is an anionic phosphoric acid ester, at least one mole of ethylene oxide (“EO”) can be included per mole of the phosphoric acid ester, and the phosphoric acid ester may include 2 moles or more of EO per mole of the phosphoric acid ester, or may also include more than 4 moles of EO per mole of the phosphoric acid ester. It is thought that a solubilizing group such as an EO group prevents a precipitate forming reaction between the ink composition and reactive components. Therefore, by preparing the phosphoric acid ester so as to include sufficient solubilizing EO groups, the ink composition is stable against agglomeration and precipitation, and can suppress adhesion and deposition of aggregates to the head.

The phosphoric acid ester may be included in an amount of about 0.01% by mass to about 10% by mass relative to the total mass of the ink composition. The content of the phosphoric acid ester is preferably 0.2% by mass to about 5% by mass, more preferably 0.4% by mass to about 5% by mass, and even more preferably 0.6% by mass to about 3% by mass, from the viewpoint of suppressing white streaks of images.

(Other Surfactant)

The ink composition of the invention can contain another surfactant other than the phosphoric acid ester surfactant, as necessary. The surfactant can be used as a surface tension adjusting agent.

As a surface tension adjusting agent, a compound having a structure that has both a hydrophilic moiety and a hydrophobic moiety in the molecule, and the like can be effectively used, and anionic surfactants, cationic surfactants, amphoteric surfactants, nonionic surfactants and betaine-based surfactants can all be used. Furthermore, a dispersant (polymeric dispersant) may also be used as a surfactant.

According to the invention, from the viewpoint of suppressing interference in the droplet ejection of the ink composition, nonionic surfactants are preferable, and among them, acetylene glycol derivatives are more preferable.

When a surfactant (surface tension adjusting agent) is incorporated into the ink composition, from the viewpoint of satisfactorily performing the ejection of the ink composition by an inkjet method, the surfactant is contained in an amount that can adjust the surface tension of the ink composition to 20 mN/m to 60 mN/m, and from the viewpoint of surface tension, more preferably to 20 mN/m to 45 mN/m, and even more preferably 25 mN/m to 40 mN/m.

In regard to the specific amount of the surfactant in the ink composition of the surfactant, there are no particular limitations as long as the amount of the surfactant brings the surface tension to a preferable range, and the amount is preferably 1% by mass or greater, more preferably 1% to 10% by mass, and even more preferably 1% to 3% by mass.

(Water-Soluble Organic Solvent)

The ink composition according to the invention contains at least one water-soluble organic solvent as a solvent of the ink composition. When the ink composition contains a water-soluble organic solvent, effects of prevention of drying and promotion of wetting or penetration can be obtained. In the prevention of drying, the water-soluble organic solvent is used as a drying preventing agent that prevents the ink composition from adhering and drying at the ink ejection ports of the spray nozzle and from causing the generation of aggregates and clogging, and in the prevention of drying or in wetting, a water-soluble organic solvent having a lower vapor pressure than water is preferable. Furthermore, in the promotion of penetration, the water-soluble organic solvent can be used as a penetration promoting agent that increases ink penetrability to the paper.

Examples of the water-soluble organic solvent include alkanediols (polyhydric alcohols) such as glycerin, 1,2,6-hexanetriol, trimethylolpropane, ethylene glycol, and propylene glycol; sugar alcohols; C1 to C4 alkyl alcohols such as ethanol, methanol, butanol, propanol and isopropanol; and glycol ethers such as ethylene glycol monomethyl ether, ethylene glycol monoethyl ether, ethylene glycol mono-iso-propyl ether, ethylene glycol monobutyl ether (ethylene glycol mono-n-butyl ether, ethylene glycol mono-t-butyl ether), ethylene glycol monomethyl ether acetate, diethylene glycol monomethyl ether, diethylene glycol monoethyl ether, diethylene glycol mono-n-propyl ether, diethylene glycol mono-iso-propyl ether, diethylene glycol mono-t-butyl ether, triethylene glycol monoethyl ether, 1-methyl-1-methoxybutanol, propylene glycol monomethyl ether, propylene glycol monoethyl ether, propylene glycol mono-n-propyl ether, propylene glycol mono-iso-propyl ether, propylene glycol mono-t-butyl ether, dipropylene glycol, dipropyelene glycol monomethyl ether, dipropylene glycol monoethyl ether, dipropylene glycol mono-n-propyl ether, dipropylene glycol mono-iso-propyl ether, and tripropylene glycol monomethyl ether.

These can be used individually, or two or more kinds may be used together.

For the purpose of preventing drying or wetting, polyhydric alcohols are useful, for example, glycerin, ethylene glycol, diethylene glycol, triethylene glycol, propylene glycol, dipropylene glycol, tripropylene glycol, 1,3-butanediol, and 2,3-butanediol. These may be used individually, or two or more kinds may be used together.

For the purpose of promoting penetration, polyol compounds are preferable, and aliphatic diols are suitable. Examples of the aliphatic diols include 2-ethyl-2-methyl-1,3-propanediol, 3,3-dimethyl-1,2-butanediol, 2,2-diethyl-1,3-propanediol, 2-ethyl-1,3-hexanediol, and 2,2,4-trimethyl-1,3-pentanediol. Among these, preferable examples include 2-ethyl-1,3-hexanediol and 2,2,4-trimethyl-1,3-pentanediol.

The water-soluble organic solvents may be used individually, or two or more kinds may be used as mixtures.

The content of the water-soluble organic solvent is preferably from 1% by mass to 60% by mass, and more preferably from 5% by mass to 40% by mass, relative to the total mass of the ink composition.

(Water)

The ink composition according to the invention can contain water as an ink solvent, but there are no particular limitations on the content of water. Among others, the content of water is preferably from 10% by mass to 99% by mass, more preferably from 30% by mass to 80% by mass, and even more preferably from 50% by mass to 70% by mass.

(Resin Particles)

The ink composition of the invention preferably contains at least one kind of resin particles. When the ink composition contains resin particles, suppression of white streaks in the image by the ink composition on the recording media, fixability, and anti-blocking properties, offset resistance and scratch resistance of images can be effectively enhanced.

The resin particles preferably have a function of fixing an image formed by the ink composition, by undergoing agglomeration or dispersion unstabilization when brought into contact with the treatment liquid or a paper area in which the treatment liquid has been dried, and thereby thickening the ink composition. Such resin particles are preferably in a state of being dispersed in water and at least one organic solvent.

Examples of the resin particles include resin particles formed from thermoplastic (meth)acrylic resins, epoxy resins, polyurethane resins, polyether resins, polyamide resins, unsaturated polyester resins, phenolic resins, silicone resins and fluorine-based resins; polyvinyl-based resins such as vinyl chloride, vinyl acetate, polyvinyl alcohol and polyvinyl butyral; polyester-based resins such as alkyd resins and phthalate resins; copolymers thereof and mixtures thereof.

The resin particles according to the invention are preferably particles of a self-dispersing polymer, and more preferably particles of a self-dispersing polymer having a carboxyl group, from the viewpoint of liquid stability (particularly, dispersion stability) in the case of using a pigment. The particles of a self-dispersing polymer (hereinafter, also referred to as “self-dispersing polymer particles”) mean particles of a water-insoluble polymer which can be brought to a dispersed state in an aqueous medium in the absence of other surfactants, only by means of the functional group (particularly, an acidic group or a salt thereof) carried by the polymer itself, and which does not contain a free emulsifying agent.

Here, the term dispersed state includes both an emulsified state (emulsion) in which a water-insoluble polymer is dispersed in a liquid state in an aqueous medium, and a dispersed state (suspension) in which a water-insoluble polymer is dispersed in a solid state in an aqueous medium.

The water-insoluble polymer is preferably a water-insoluble polymer which can be brought to a dispersed state in which the water-insoluble polymer is dispersed in a solid state, from the viewpoints of the rate of agglomeration and fixability when used in the ink composition.

The dispersed state of the self-dispersing polymer particles refers to a state in which, even after a solution is prepared by dissolving 30 g of a water-insoluble polymer in 70 g of an organic solvent (for example, methyl ethyl ketone), a neutralizing agent capable of neutralizing 100% of salt-forming groups of the water-insoluble polymer (if the salt-forming group is anionic, sodium hydroxide; if the salt-forming group is cationic, acetic acid), and 200 g of water are mixed and stirred (apparatus: stirring apparatus with a stirring blade, speed of rotation 200 rpm, for 30 minutes, 25° C.), and then the organic solvent is removed from the mixture liquid, it can be visually confirmed that the dispersed state stably exists for at least one week at 25° C.

Furthermore, the water-insoluble polymer refers to a polymer which gives an amount of dissolution of 10 g or less when the polymer is dried at 105° C. for 2 hours and then dissolved in 100 g of water at 25° C., and the amount of dissolution is preferably 5 g or less, and more preferably 1 g or less. The amount of dissolution is an amount of dissolution obtainable when the water-insoluble polymer is 100% neutralized with sodium hydroxide or acetic acid in accordance with the type of the salt-forming group.

The aqueous medium is constituted to include water, and may optionally include a water-soluble organic solvent. According to the invention, the aqueous medium is preferably composed of water and a water-soluble organic solvent in an amount of 0.2% by mass or less based on water, and is more preferably composed of water. The water-soluble organic solvent is the same as the water-soluble organic solvent which is preferably contained in the ink composition, and preferable examples thereof are also the same.

There are no particular limitations on the main chain skeleton of the resin that constitutes the resin particles according to the invention, and for example, a vinyl polymer or a condensed polymer (epoxy resin, polyester, polyurethane, polyamide, cellulose, polyether, polyurea, polyimide, polycarbonate, or the like) can be used. Among them, a vinyl polymer is particularly preferable, and from the viewpoint of the dispersion stability of the resin particles, (meth)acrylic resin particles are more preferable.

Here, the (meth)acrylic resin means a methacrylic resin and an acrylic resin.

Suitable examples of the vinyl polymer and the monomer that constitutes a vinyl polymer include those described in JP2001-181549A and JP2002-88294A. Furthermore, use can also be made of a vinyl polymer into which a dissociable group is introduced at the ends of the polymer chain by radical polymerization of a vinyl monomer using a chain transfer agent, a polymerization initiator or an iniferter, each having a dissociable group (or a substituent which can be derived into a dissociable group), or by ionic polymerization using a compound having a dissociable group (or a substituent which can be derived into a dissociable group) in an initiator or a terminator.

Suitable examples of the condensed polymer and the monomer that constitutes a condensed polymer include those described in JP2001-247787A.

The self-dispersing polymer particles according to the invention preferably contain a water-insoluble polymer containing at least one of a constituent unit derived from an aromatic group-containing monomer and a constituent unit derived from an alicyclic monomer as a hydrophilic constituent unit and a hydrophobic constituent unit, from the viewpoint of self-dispersibility.

The hydrophilic constituent unit is not particularly limited as long as it is a constituent unit derived from a hydrophilic group-containing monomer, and the constituent unit may be derived from a monomer containing one kind of hydrophilic group, or may be derived from a monomer containing two or more kinds of hydrophilic groups. There are no particular limitations on the hydrophilic group, and the hydrophilic group may be a dissociable group or a nonionic hydrophilic group.

The hydrophilic group according to the invention is preferably a dissociable group, and more preferably an anionic dissociable group, from the viewpoint of promoting self-dispersion and from the viewpoint of stability of the emulsified or dispersed state thus formed. Examples of the dissociable group include a carboxyl group, a phosphate group and a sulfonate group, and among them, a carboxyl group is preferable from the viewpoint of fixability obtainable when the ink composition is formulated.

The hydrophilic group-containing monomer is preferably a dissociable group-containing monomer from the viewpoints of self-dispersibility and agglomerating properties, and is more preferably a dissociable group-containing monomer having a dissociable group and an ethylenically unsaturated bond.

Examples of the dissociable group-containing monomer include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxymethylsuccinic acid. Specific examples of the unsaturated sulfonic acid monomer include styrenesulfonic acid, 2-acrylamido-2-methylpropanesulfonic acid, 3-sulfopropyl(meth)acrylate, and bis(3-sulfopropyl)-itaconic acid ester. Specific examples of the unsaturated phosphoric acid monomer include vinylphosphonic acid, vinyl phosphate, bis(methacryloxyethyl)phosphate, diphenyl-2-acryloyloxyethyl phosphate, diphenyl-2-methacryloyloxyethyl phosphate, and dibutyl-2-acryloyloxyethyl phosphate.

Among the dissociable group-containing monomers, an unsaturated carboxylic acid monomer is preferable, and at least one of acrylic acid and methacrylic acid is more preferable, from the viewpoints of dispersion stability and ejection stability.

Examples of the monomer having a nonionic hydrophilic group include ethylenically unsaturated monomers having a (poly)ethyleneoxy group or a polypropyleneoxy group, such as 2-methoxyethyl acrylate, 2-(2-methoxyethoxy)ethyl acrylate, 2-(2-methoxyethoxy)ethyl methacrylate, ethoxytriethylene glycol methacrylate, methoxypolyethylene glycol (molecular weight 200 to 1000) monomethacrylate, and polyethylene glycol (molecular weight 200 to 1000) monomethacrylate; and ethylenically unsaturated monomers having a hydroxyl group, such as hydroxymethyl(meth)acrylate, 2-hydroxyethyl(meth)acrylate, 2-hydroxypropyl(meth)acrylate, 4-hydroxybutyl(meth)acrylate, hydroxypentyl(meth)acrylate, and hydroxyhexyl(meth)acrylate.

Furthermore, as the monomer having a nonionic hydrophilic group, an ethylenically unsaturated monomer having an alkyl ether at the ends is preferred to an ethylenically unsaturated monomer having a hydroxyl group at the ends, from the viewpoints of the stability of particles and the content of water-soluble components.

The hydrophilic constituent unit is preferably any of an embodiment which contains only a hydrophilic unit having an anionic dissociable group, and an embodiment which contains both a hydrophilic constituent unit having an anionic dissociable group and a hydrophilic constituent unit having a nonionic hydrophilic group.

Furthermore, an embodiment which contains two or more kinds of a hydrophilic constituent unit having an anionic dissociable group, or an embodiment which uses two or more kinds of a hydrophilic constituent unit having an anionic dissociable group and a hydrophilic constituent unit having a nonionic hydrophilic group in combination, are also preferable.

The content of the hydrophilic constituent unit in the self-dispersing polymer is preferably 25% by mass or less, more preferably 1% to 25% by mass, even more preferably 2% to 23% by mass, and particularly preferably 4% to 20% by mass, from the viewpoints of the viscosity and stability over time of the ink composition.

When the self-dispersing polymer has two or more kinds of hydrophilic constituent units, it is preferable that the total content of the hydrophilic constituent units is in the range described above.

The content of the constituent unit having an anionic dissociable group in the self-dispersing polymer is preferably in the range that may give an acid value in the suitable range that will be described later.

Furthermore, the content of the constituent unit having a nonionic hydrophilic group is preferably 0% to 25% by mass, more preferably 0% to 20% by mass, and particularly preferably 0% to 15% by mass, from the viewpoints of ejection stability and stability over time.

The self-dispersing polymer particles preferably contain a polymer having a carboxyl group, and more preferably contain a polymer which has a carboxyl group and has an acid value (mg KOH/g) of 25 to 100, from the viewpoints of self-dispersibility and the rate of agglomeration when brought into contact with the treatment liquid. Furthermore, the acid value is more preferably 25 to 80, and particularly preferably 30 to 65, from the viewpoints of self-dispersibility and the rate of agglomeration when brought into contact with the treatment liquid.

Particularly, when the acid value is 25 or greater, satisfactory stability of self-dispersibility is obtained, and when the acid value is 100 or less, agglomerating properties are enhanced.

The aromatic group-containing monomer is not particularly limited as long as it is a compound containing an aromatic group and a polymerizable group. The aromatic group may be a group derived from an aromatic hydrocarbon, or may be a group derived from an aromatic heterocycle. According to the invention, from the viewpoint of particle shape stability in an aqueous medium, the aromatic group is preferably an aromatic group derived from an aromatic hydrocarbon.

The polymerizable group may be a polymerizable group that is polycondensation reactive, or may be a polymerizable group that is addition polymerizable. According to the invention, from the viewpoint of particle shape stability in an aqueous medium, the polymerizable group is preferably a polymerizable group that is addition polymerizable, and more preferably a group containing an ethylenically unsaturated bond.

The aromatic group-containing monomer according to the invention is preferably a monomer having an aromatic group derived from an aromatic hydrocarbon and an ethylenically unsaturated bond. The aromatic group-containing monomer may be used individually, or two or more kinds may be used in combination.

Examples of the aromatic group-containing monomer include phenoxyethyl(meth)acrylate, benzyl(meth)acrylate, phenyl(meth)acrylate, and styrene-based monomers. Among these, from the viewpoints of the balance between hydrophilicity and hydrophobicity of the polymer chain and ink fixability, aromatic group-containing (meth)acrylate monomers are preferable, and at least one selected from phenoxyethyl(meth)acrylate, benzyl(meth)acrylate, and phenyl(meth)acrylate is more preferable, while phenoxyethyl(meth)acrylate and benzyl(meth)acrylate are even more preferable.

It is preferable that the self-dispersing polymer particles according to the invention contain a constituent unit derived from an aromatic group-containing (meth)acrylate monomer, and the content thereof is 10% to 95% by mass. When the content of the constituent unit derived from an aromatic group-containing (meth)acrylate monomer is 10% to 95% by mass, the stability of the self-emulsified or self-dispersed state is improved, and an increase in the ink viscosity can be suppressed.

According to the invention, from the viewpoints of stability of the self-dispersed state, stabilization of the particle shape in an aqueous medium due to the hydrophobic interaction between aromatic rings, and a decrease in the amount of water-soluble components due to appropriate hydrophobization of the particles, the content of the constituent unit derived from an aromatic group-containing (meth)acrylate monomer is more preferably 15% to 90% by mass, even more preferably 15% to 80% by mass, and particularly preferably 25% to 70% by mass.

Furthermore, when a styrene-based monomer is used as the aromatic group-containing monomer, from the viewpoint of the stability obtainable when the self-dispersing polymer particles are produced, the content of the constituent unit derived from a styrene-based monomer is preferably 20% by mass or less, more preferably 10% by mass or less, and even more preferably 5% by mass or less, and an embodiment that does not contain a constituent unit derived from a styrene-based monomer is particularly preferable.

Here, a styrene-based monomer refers to a substituted styrene (α-methylstyrene, chlorostyrene, or the like), and a styrene macromer having a polystyrene structural unit.

The alicyclic monomer is not particularly limited as long as it is a compound containing an alicyclic hydrocarbon group and a polymerizable group, but from the viewpoint of dispersion stability, the alicyclic monomer is preferably an alicyclic(meth)acrylate.

The alicyclic(meth)acrylate is a compound containing a structural moiety derived from (meth)acrylic acid and a structural moiety derived from an alcohol, and having a structure which contains at least one unsubstituted or substituted alicyclic hydrocarbon group. Furthermore, the alicyclic hydrocarbon group may be a structural moiety derived from an alcohol itself, or may be bonded to a structural moiety derived from an alcohol via a linking group.

Furthermore, the term “alicyclic(meth)acrylate” means a methacrylate or acrylate having an alicyclic hydrocarbon group.

The alicyclic hydrocarbon group is not particularly limited as long as it includes a cyclic non-aromatic hydrocarbon group, and examples include a monocyclic hydrocarbon group, a bicyclic hydrocarbon group, and a polycyclic hydrocarbon group having three or more rings.

The molecular weight range of the self-dispersing polymer according to the invention is, as the weight average molecular weight, preferably 3000 to 200,000, more preferably 5000 to 150,000, and even more preferably 10,000 to 100,000. Furthermore, the self-dispersing polymer is preferably a polymer having an acid value of 25 to 100 and a weight average molecular weight of 3000 to 200,000, and more preferably a polymer having an acid value of 25 to 95, and a weight average molecular weight of 5000 to 150,000. When the weight average molecular weight is adjusted to 3000 or greater, the amount of water-soluble components can be effectively suppressed. If the weight average molecular weight is adjusted to 200,000 or less, self-dispersion stability can be increased.

The weight average molecular weight is measured by gel permeation chromatography (GPC). GPC is carried out using an HLC-8020 GPC (manufactured by Tosoh Corp.), and three columns of TKSgel SuperHZM-H, TSKgel SuperHZ4000, and TSKgel SuperHZ200 (manufactured by Tosoh Corp., 4.6 mm ID×15 cm) are used. Tetrahydrofuran (THF) is used as an eluent. Furthermore, GPC is carried out under the conditions of a sample concentration of 0.35% by mass, a flow rate of 0.35 ml/min, a sample injection amount of 10 μl, and a measurement temperature of 40° C., using a reflective index (RI) detector. A calibration curve is produced using 8 samples of “Standard Sample TSK standard, polystyrene”: “F-40”, “F-20”, “F-4”, “F-1”, “A-5000”, “A-2500”, “A-1000” and “n-propylbenzene” manufactured by Tosoh Corp.

The self-dispersing polymer according to the invention is, from the viewpoint of controlling the hydrophilicity and hydrophobicity of the polymer, preferably a polymer which includes a structural unit derived from an aromatic group-containing (meth)acrylate monomer (preferably a structural unit derived from phenoxyethyl(meth)acrylate and/or a structural unit derived from benzyl(meth)acrylate) in an amount of 15% to 80% as a copolymerization ratio relative to the total mass of the self-dispersing polymer particles, and has an acid value of 25 to 100 and a weight average molecular weight of 3000 to 200,000.

Furthermore, the self-dispersing polymer is, from the viewpoint of controlling the hydrophilicity and hydrophobicity of the polymer, preferably a polymer which includes a constituent unit derived from an aromatic group-containing (meth)acrylate monomer in an amount of 15% to 80% by mass as a copolymerization ratio, a constituent unit derived from a carboxyl group-containing monomer, and a constituent unit derived from an alkyl group-containing monomer (preferably, a structural unit derived from an alkyl ester of (meth)acrylic acid), and is more preferably a polymer which includes a structural unit derived from phenoxyethyl(meth)acrylate and/or a structural unit derived from benzyl(meth)acrylate in an amount of 15% to 80% as a copolymerization ratio, and a constituent unit derived from a carboxyl group-containing monomer and a constituent unit derived from an alkyl group-containing monomer (preferably, a structural unit derived from a C1 to C4 alkyl ester of (meth)acrylic acid), and has an acid value of 25 to 95 and a weight average molecular weight of 5000 to 150,000.

The self-dispersing polymer of the invention is also preferably a vinyl polymer which includes a structure derived from an alicyclic(meth)acrylate in an amount of from 20% by mass to 90% by mass as a copolymerization ratio, and at least one of a structure derived from a dissociable group-containing monomer and a structure derived from a (meth)acrylate containing a C1 to C8 chain alkyl group, and has an acid value of 20 to 120, a total content of hydrophilic structural units of 25% by mass or less, and a weight average molecular weight of 3000 to 200,000, from the viewpoint of controlling the hydrophilicity and hydrophobicity of the polymer.

Furthermore, the self-dispersing polymer is more preferably a vinyl polymer which includes a structure derived from a bicyclic or polycyclic(meth)acrylate having three or more rings in an amount of equal to or greater than 30% by mass and less than 90% by mass as a copolymerization ratio, a structure derived from a (meth)acrylate containing a C1 to C4 chain alkyl group in an amount of equal to or greater than 10% by mass and less than 70% by mass as a copolymerization ratio, and a structure derived from a carboxyl group-containing monomer in an amount which gives an acid value in the range of 25 to 100, and has a total content of hydrophilic structural units of 25% by mass or less and a weight average molecular weight of 10,000 to 200,000.

The self-dispersing polymer is particularly preferably a vinyl polymer which includes a structure derived from a bicyclic or polycyclic(meth)acrylate having three or more rings in an amount of equal to or greater than 40% by mass and less than 80% by mass as a copolymerization ratio, at least a structure derived from methyl(meth)acrylate or ethyl(meth)acrylate in an amount of equal to or greater than 20% by mass and less than 60% by mass as a copolymerization ratio, and a structure derived from acrylic acid or methacrylic acid in an amount which gives an acid value in the range of 30 to 80, and has a total content of hydrophilic structural units of 25% by mass or less and a weight average molecular weight of 30,000 to 150,000.

There are no particular limitations on the method for producing the water-insoluble polymer that constitutes the resin particles according to the invention, and examples include a method of performing emulsion polymerization in the presence of a polymerizable surfactant, and thereby covalently bonding the surfactant to a water-insoluble polymer; and a method of copolymerizing a monomer mixture containing the hydrophilic group-containing monomer and an aromatic group-containing monomer by a known polymerization method such as a solution polymerization method or a bulk polymerization method. Among the polymerization methods, a solution polymerization method is preferable from the viewpoints of the rate of agglomeration and the droplet ejection stability obtainable when the ink composition is formulated, and a solution polymerization method using an organic solvent is more preferable.

The self-dispersing polymer particles according to the invention are, from the viewpoint of the rate of agglomeration, preferably a polymer dispersion which contains a polymer that is synthesized in an organic solvent, the polymer having a carboxyl group (preferably, having an acid value of 20 to 100) and having a part or all of the carboxyl groups of the polymer neutralized, and contains water as a continuous phase. That is, the preparation of the self-dispersing polymer particles according to the invention is preferably carried out by a step of synthesizing a polymer in an organic solvent, and a dispersing step of making an aqueous dispersion in which at least a part of the carboxyl groups of the polymer has been neutralized.

The dispersing step preferably includes the following step (1) and step (2).

Step (1): A step of stirring a mixture containing a polymer (water-insoluble polymer), organic solvent, neutralizing agent, and an aqueous medium.

Step (2): A step of removing the organic solvent from the mixture.

The step (1) is preferably a treatment of first dissolving a polymer (water-insoluble polymer) in an organic solvent, subsequently slowly adding a neutralizing agent and an aqueous medium to the solution, and mixing and stirring the mixture to obtain a dispersion. As such, by adding a neutralizing agent and an aqueous medium to a water-insoluble polymer solution dissolved in an organic solvent, self-dispersing polymer particles having a particle size which exhibits higher storage stability can be obtained, without necessitating strong shear force.

There are no particular limitations on the stirring method of the mixture, and a mixing and stirring apparatus is generally used, or as necessary, a dispersing machine such as an ultrasonic disperser or a high pressure homogenizer can be used.

Preferable examples of the organic solvent include alcohol-based solvents, ketone-based solvents and ether-based solvents.

Examples of the alcohol-based solvents include isopropyl alcohol, n-butanol, t-butanol, and ethanol. Examples of the ketone-based solvent include acetone, methyl ethyl ketone, diethyl ketone, and methyl isobutyl ketone. Examples of the ether-based solvent include dibutyl ether, and dioxane. Among these solvents, ketone-based solvents such as methyl ethyl ketone, and alcohol-based solvents such as isopropyl alcohol are preferable. Furthermore, for the purpose of mitigating the polarity change during the phase transition from an oil system to an aqueous system, it is also preferable to use isopropyl alcohol and methyl ethyl ketone together. When those solvents are used together, self-dispersing polymer particles having a microparticle size which gives high dispersion stability can be obtained without any occurrence of aggregate sedimentation or fusion between particles.

The neutralizing agent is used in order to make a part or all of the dissociable groups neutralized and to thereby allow the self-dispersing polymer to form a stable emulsified or dispersed state in water. When the self-dispersing polymer of the invention has an anionic dissociable group (for example, a carboxyl group) as a dissociable group, examples of the neutralizing agent that can be used include basic compounds such as organic amine compounds, ammonia, and hydroxides of alkali metals. Examples of the organic amine compounds include monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and triisopropanolamine. Examples of the hydroxides of alkali metals include lithium hydroxide, sodium hydroxide, and potassium hydroxide. Among them, from the viewpoint of dispersion stabilization of the self-dispersing polymer particles of the invention in water, sodium hydroxide, potassium hydroxide, triethylamine and triethanolamine are preferable.

These basic compounds are preferably used in an amount of 5% to 120% by mole, more preferably 10% to 110% by mole, and even more preferably 15% to 100% by mole, relative to 100% by mole of the dissociable group. When the amount is 15% by mole or greater, an effect of stabilizing the dispersion of particles in water is exhibited, and when the amount is 100% by mole or less, an effect of reducing the amount of water-soluble components is obtained.

In the step (2), an aqueous dispersion of the self-dispersing polymer particles can be obtained by distilling off the organic solvent from the dispersion obtained in the step (1) by a routine method such as distillation under reduced pressure, and thereby achieving phase transition to an aqueous system. The organic solvent in the aqueous dispersion thus obtained is substantially completely removed, and the amount of the organic solvent is preferably 0.2% by mass or less, and more preferably 0.1% by mass or less.

The average particle size of the resin particles is, in terms of volume average particle size, preferably in the range of 10 nm to 1 μm, more preferably in the range of 10 nm to 200 nm, even more preferably in the range of 10 nm to 100 nm, and particularly preferably in the range of 10 nm to 50 nm. When the volume average particle size is 10 nm or greater, the production suitability is improved, and when the volume average particle size is 1 μm or less, storage stability is improved.

Furthermore, there are no particular limitations on the particle size distribution of the resin particles, and the resin particles may have any of a wide particle size distribution or a monodisperse particle size distribution. It is also acceptable to mix two or more kinds of resin particles having a monodisperse particle size distribution.

Here, the average particle size and the particle size distribution of the resin particles are determined by a dynamic light scattering method using a Nanotrac particle size distribution analyzer, UPA-EX150 (manufactured by Nikkiso Co., Ltd.).

In regard to the resin particles (particularly, self-dispersing polymer particles), one kind of particles can be used alone, or two or more kinds can be used as a mixture.

The content of the resin particles in the ink composition is preferably 0.5% to 20% by mass, more preferably 2% to 20% by mass, and even more preferably 3% to 15% by mass, relative to the total mass of the ink composition.

(Other Components)

The ink composition can optionally further contain various additives as other components, in addition to the components described above.

Examples of the various additives include known additives such as an ultraviolet absorbent, a discoloration preventing agent, an antifungal agent, a pH adjusting agent, an antirust agent, an antioxidant, an emulsion stabilizer, an antiseptic agent, a defoamant, a viscosity adjusting agent, a dispersion stabilizer, a chelating agent, and a solid wetting agent.

Examples of the ultraviolet absorbent include benzophenone-based ultraviolet absorbents, benzotriazole-based ultraviolet absorbents, salicylate-based ultraviolet absorbents, cyanoacrylate-based ultraviolet absorbents, and nickel complex salt-based ultraviolet absorbents.

Various organic and metal complex-based discoloration preventing agents can be used as the discoloration preventing agent. Examples of the organic discoloration preventing agents include hydroquinones, alkoxyphenols, dialkoxyphenols, phenols, anilines, amines, indanes, chromanes, alkoxyanilines, and heterocycles. Examples of the metal complexes include nickel complexes, and zinc complexes.

Examples of the antifungal agent include sodium dehydroacetate, sodium benzoate, sodium pyridinethione-1-oxide, p-hydroxybenzoic acid ethyl ester, 1,2-benzisothiazolin-3-one, sodium sorbate, and sodium pentachlorophenol.

The content of the antifungal agent in the ink composition is preferably in the range of 0.02% to 1.00% by mass.

There are no particular limitations on the pH adjusting agent, as long as the compound can adjust the pH to a desired value without exerting adverse effects on the ink composition that is prepared, and the pH adjusting agent can be appropriately selected according to the purpose. Examples thereof include alcoholamines (for example, diethanolamine, triethanolamine, and 2-amino-2-ethyl-1,3-propanediol), alkali metal hydroxides (for example, lithium hydroxide, sodium hydroxide, and potassium hydroxide), ammonium hydroxides (for example, ammonium hydroxide, and quaternary ammonium hydroxide), phosphonium hydroxides, and alkali metal carbonates.

Examples of the antirust agent include acidic sulfites, sodium thiosulfate, ammonium thiodiglycolate, diisopropylammonium nitrite, pentaerythritol tetranitrate, and dicyclohexylammonium nitrite.

Examples of the antioxidant include phenol-based antioxidants (including hindered phenol-based antioxidants), amine-based antioxidants, sulfur-based antioxidants, and phosphorus-based antioxidants.

Examples of the chelating agent include sodium ethylenediamine tetraacetate, sodium nitrilotriacetate, sodium hydroxyethylenediamine triacetate, sodium diethylenetriamine pentaacetate, and sodium uranyl diacetate.

Examples of the solid wetting agent include sugars such as glucose, mannose, fructose, ribose, xylose, arabinose, galactose, aldonic acid, glucitol, maltose, cellobiose, lactose, sucrose, trehalose, and maltotriose; sugar alcohols; hyaluronic acids; and ureas.

—Properties of Ink Composition—

The pH (25° C.) of the ink composition is preferably 7 to 10, and more preferably in the range of 7.5 to 9, from the viewpoint of the rate of agglomeration of the ink composition.

The value of pH of the ink composition is measured at 25° C. using a pH meter manufactured by DDK-Toa Corp., WM-50EG

The surface tension (25° C.) of the ink composition is preferably from 20 mN/m to 60 mN/m, more preferably from 20 mN/m to 45 mN/m, and even more preferably from 25 mN/m to 40 mN/m.

The surface tension of the ink composition is measured under the conditions of 25° C., using an Automatic Surface Tensiometer, CBVP-Z (manufactured by Kyowa Interface Science Co., Ltd.).

The viscosity of the ink composition of the invention at 25° C. is preferably from 1.2 mPa·s to 15.0 mPa·s, more preferably equal to or greater than 2 mPa·s and less than 13 mPa·s, and even more preferably equal to or greater than 2.5 mPa·s and less than 10 mPa·s.

The viscosity of the ink composition is measured under the conditions of 25° C. using a VISCOMETER, TV-22 (manufactured by Toki Sangyo Co., Ltd.).

[Treatment Liquid]

The treatment liquid according to the invention contains at least one cationic polymer which agglomerates the self-dispersing pigment when brought into contact with the ink composition.

When the treatment liquid contains a cationic polymer, the rate of aggregate formation due to the contact with the ink composition is effectively improved, and therefore, white streaks of the image are suppressed, while scratch resistance of the image and maintenance properties are enhanced.

(Cationic Polymer)

As the cationic polymer, any polymer that agglomerates the self-dispersing pigment according to the invention can be used without any particular limitations.

Examples of the cationic polymer include poly(vinylpyridine) salts, polyalkylaminoethyl acrylate, polyalkylaminoethyl methacrylate, poly(vinylimidazole), polyethyleneimine, polyguanidine (for example, polybiguanide, and polyguanide), polyallylamine, and other polyamines including quaternary polyamine.

Examples of the polyguanidine include, as a polybiguanide, a polymer of hexamethylene biguanide; and as a polyguanide, a polymer of hexamethylene guanide, and Vantocil (registered trademark, Avecia, Inc.).

Among them, it is preferable that the cationic polymer includes at least one polyguanidine, from the viewpoints of scratch resistance and maintenance.

The cationic polymer may be used individually, or two or more kinds may be used together.

In regard to the weight average molecular weight of the cationic polymer, a smaller molecular weight is preferable from the viewpoint of the viscosity of the treatment liquid. In the case of applying the treatment liquid on the recording medium by an inkjet system, the weight average molecular weight is preferably in the range of 500 to 500,000, more preferably in the range of 700 to 200,000, and even more preferably in the range of 1000 to 100,000.

When the weight average molecular weight is 500 or greater, it is advantageous in view of the rate of agglomeration, and when the weight average molecular weight is 500,000 or less, it is advantageous in view of ejection reliability. However, an exception is made when the treatment liquid is applied on the recording medium by a method other than an inkjet method.

The content of the cationic polymer is preferably 1% to 35% by mass, and more preferably 5% to 25% by mass, relative to the total mass of the treatment liquid.

The amount of application of the cationic polymer on a coated paper is not particularly limited as long as it is an amount sufficient for stabilizing the ink composition, and from the viewpoint of making fixing the ink composition easier, the amount of application is preferably 0.5 g/m² to 4.0 g/m², and more preferably 0.9 g/m² to 3.75 g/m².

(Other Components)

The treatment liquid according to the invention may contain a fixing agent other than the cationic polymer that agglomerates the ink composition. As the fixing agent, an acidic substance or a polyvalent metal compound may be added, particularly to the extent of not impairing the effects of the invention.

In general, the treatment liquid according to the invention may contain a water-soluble organic solvent, and can be formulated using various other additives. The details of the water-soluble organic solvent and the various other additives are the same as those contained in the ink composition according to the invention.

The pH (25° C.) of the treatment liquid is preferably 1.0 to 10.0, and more preferably 2.0 to 9.0.

In regard to the pH of the reaction liquid, the value measured at 25° C. using a pH meter, WM-50EG manufactured by DDK-Toa Corp. is used.

The surface tension (25° C.) of the treatment liquid is preferably from 20 mN/m to 60 mN/m, from the viewpoint of the rate of agglomeration of the ink composition. The surface tension is more preferably from 25 mN/m to 50 mN/m, and even more preferably from 25 mN/m to 45 mN/m.

The surface tension of the treatment liquid is measured under the conditions of 25° C. using an Automatic Surface Tensiometer, CBVP-Z (manufactured by Kyowa Interface Science Co., Ltd.).

The viscosity (25° C.) of the treatment liquid is preferably in the range of 1 mPa·s to 30 mPa·s, more preferably in the range of 1 mPa·s to 20 mPa·s, even more preferably in the range of 2 mPa·s to 15 mPa·s, and particularly preferably in the range of 2 mPa·s to 10 mPa·s, from the viewpoint of the rate of agglomeration of the ink composition.

According to the invention, the viscosity of the treatment liquid is measured under the conditions of 25° C. using a VISCOMETER, TV-22 (manufactured by Toki Sangyo Co., Ltd.).

<Image Forming Method>

The image forming method of the invention includes an ink applying step of applying an ink composition containing a self-dispersing pigment having a carboxyl group at the surface of the pigment, a water-soluble organic solvent, a phosphoric acid ester and water, on a recording medium by an inkjet method; and a treatment liquid applying step of applying a treatment liquid containing a cationic polymer which agglomerates the self-dispersing pigment in the ink composition, on the recording medium.

The image forming method of the invention may further include, as necessary, other steps such as an ink drying step of drying and removing the water-soluble organic solvent in the ink composition that has been applied on the recording medium, or a heating and fixing step of fusion fixing the resin particles contained in the ink composition.

The ink composition and the treatment liquid used in the image forming method of the invention have the same definitions as those described in connection with the ink set of the invention, and preferable examples are also the same.

According to the invention, the recording medium is preferably a coated paper. That is, it is preferable to form an image on a coated paper, which is represented by art paper or coat paper, as a recording medium, using an ink composition containing a colorant and a treatment liquid containing a cationic polymer, which is an agglomerating component that agglomerates the components in the ink composition.

During the image forming process, when the amount of the treatment liquid is selected and applied while considering that the treatment liquid contains a specific cationic polymer, image fixation can be rapidly carried out by using the agglomeration reaction efficiently.

Accordingly, there is no change such as surface roughening occurring on the paper surface to impair the final image surface, and fine lines or fine image areas can be delicately and uniformly drawn. Furthermore, when the ink composition is applied in a wide area such as in solid image recording, the occurrence of unevenness is suppressed so that images with high density uniformity can be obtained, and at the same time, scratch resistance (adhesiveness to paper) and offset properties of the image are also improved. The formation of high density images is also made possible, and satisfactory color reproducibility of images is also obtained.

In regard to the image forming method of the invention, any of the treatment liquid applying step and the ink applying step may be carried out prior to the other. From the viewpoints of drawing fine lines or fine image areas more delicately and uniformly, or reducing the occurrence of white streaks or unevenness as much as possible when ink is applied in a wide area such as in solid image recording to further increase the density uniformity, and thereby further improve the image quality, scratch resistance and offset resistance, an embodiment of forming an image by applying the treatment liquid on a recording medium through the treatment liquid applying step, and then applying the ink composition through the ink applying step, is preferable. When the treatment liquid is applied on the recording medium, the treatment liquid can be applied on a part of the paper or over the entire surface of the paper, but it is preferable to apply the treatment liquid over the entire surface of the paper.

[Treatment Liquid Applying Step]

In the treatment liquid applying step according to the invention, a treatment liquid containing a specific cationic polymer, which is a component capable of agglomerating (also referred to as “fixing”) the components in the ink composition according to the invention, is applied on a recording medium (preferably, a coated paper). When the image forming method is constituted such that an image is formed by using the ink composition in the presence of the treatment liquid, an image forming method exhibiting excellent maintenance properties can be obtained, and images having satisfactory image quality after image formation, and satisfactory scratch resistance can be formed.

Application of the treatment liquid on a recording medium can be carried out using any known liquid application method without any particular limitations, and any methods such as spray coating, coating with a coating roller, application by an inkjet system, and immersion can be selected. However, application by an inkjet system, which does not involve a complicated system, is preferable.

The amount of application of the treatment liquid in the treatment liquid applying step is not particularly limited, but the amount may be, for example, 0.01 g/m² to 5 g/m². From the viewpoints of offset resistance and image quality, the amount of application is preferably 0.1 g/m² to 4.5 g/m², and more preferably 0.2 g/m² to 4.0 g/m².

The area in which the treatment liquid is applied may be subjected to full-area application in which the treatment liquid is applied over the entire surface of the recording medium (coated paper), or may be subjected to partial application in which the treatment liquid is partially applied in the area where an image is formed by applying the ink composition by an inkjet method in the subsequent ink applying step.

According to the invention, from the viewpoints of uniformly adjusting the amount of application of the treatment liquid, uniformly recording fine lines or fine image areas, and suppressing density unevenness such as image unevenness, full-area application in which the treatment liquid is applied over the entire surface of the coated paper by coating using a coating roller, is preferable.

There are no particular limitations on the amount of application of the treatment liquid in the treatment liquid applying step, but the amount of application may be, for example, 0.01 g/m² to 5 g/m². From the viewpoints of offset resistance and image quality, the amount of application is preferably 0.1 g/m² to 4.5 g/m², and more preferably 0.2 g/m² to 4.0 g/m².

[Ink Applying Step]

The ink applying step according to the invention forms an image by applying an ink composition containing a self-dispersing pigment as a colorant on a recording medium.

The ink composition has the same definition as that described in the section for the ink composition described above in the ink set of the invention, and preferable examples are also the same.

The ink applying step is not particularly limited as long as an image can be recorded by applying an ink composition on a recording medium by an inkjet system. In the image formation using an inkjet system, a colored image is formed by ejecting the ink composition on a recording medium by supplying energy. In addition, as a preferable inkjet recording method of the invention, the method described in paragraphs [0093] to [0105] of JP2003-306623A can be applied.

The ink-jet method is not particularly limited and may be of any known system, for example, a charge control system of ejecting an ink by utilizing an electrostatic attraction force, a drop on demand system of utilizing a vibration pressure of a piezo element (pressure pulse system), and an acoustic inkjet system of converting electric signals into acoustic beams, irradiating them to an ink, and ejecting the ink by utilizing a radiation pressure.

Examples of the ink-jet method include a system of injecting a number of ink droplets of low concentration, a so-called “photo-ink” each in a small volume, a system of improving an image quality by using plural kinds of inks of a substantially identical hue and of different densities, and a system of using a colorless transparent ink.

[Ink Drying Step]

The image forming method of the invention may optionally further include an ink drying step of drying and removing the ink solvent (for example, water, or a water-soluble organic solvent) in the ink composition applied on the recording medium. The ink drying step is not particularly limited as long as at least a part of the ink solvent can be removed, and those conventionally used methods can be applied.

[Fixing Step]

The image forming method of the invention preferably further includes a fixing step of fixing the image formed in the ink applying step on the recording medium after the treatment liquid applying step. The fixing step is preferably a heating pressurizing fixing step of fusion fixing the resin particles which may be contained in the ink composition. Furthermore, the heating pressurizing fixing step is not particularly limited as long as it is a method of fusion fixing the resin particles contained in the ink composition, and can be appropriately selected according to the purpose.

For example, the heating pressurizing fixing step as described in JP2004-174981A can be applied in the invention.

[Recording Medium]

In the image forming method of the invention, it is preferable to use a so-called coated paper, which is used in general offset printing or the like as described above, as the recording medium. The coated paper is a paper provided with a coat layer by applying a coating material on the surface of a high-quality paper or a neutral paper, which is mainly composed of cellulose and is generally not surface-treated.

These general printing papers cause a problem in quality, such as bleeding of images and scratch resistance, in those image forming processes carried out by an inkjet system using conventional aqueous ink. In the image forming method of the invention, when an image is formed by an inkjet method, image bleeding is suppressed, and the occurrence of density unevenness is uniformly prevented. Thus, images having satisfactory scratch resistance and offset resistance can be formed.

For the coated paper, products that are generally commercially available can be purchased and used. For example, coated paper for general printing can be used, and specific examples include coat papers (A2, B2) such as “OK Topcoat+” manufactured by Oji Paper Co., Ltd.; “Aurora Coat” and “U-Lite” manufactured by Nippon Paper Group; and art paper (A1) such as “Tokubishi Art” manufactured by Mitsubishi Paper Mills, Ltd.

### EXAMPLES

Hereinafter, the invention will be more specifically described based on Examples, but the invention is not intended to be limited to the following Examples as long as the gist is maintained. Unless particularly stated otherwise, the units “part” and “%” are on a mass basis.

The weight average molecular weight was measured by gel permeation chromatography (GPC). GPC was carried out using an HLC-8020 GPC (manufactured by Tosoh Corp.), and three columns of TKSgel SuperHZM-H, TSKgel SuperHZ4000, and TSKgel SuperHZ200 (manufactured by Tosoh Corp., 4.6 mm ID×15 cm) were used. Tetrahydrofuran (THF) was used as an eluent. Furthermore, GPC was carried out under the conditions of a sample concentration of 0.35% by mass, a flow rate of 0.35 ml/min, a sample injection amount of 10 μl, and a measurement temperature of 40° C., using a refractive index (RI) detector. A calibration curve was produced using 8 samples of “Standard Sample TSK standard, polystyrene”: “F-40”, “F-20”, “F-4”, “F-1”, “A-5000”, “A-2500”, “A-1000” and “n-propylbenzene” manufactured by Tosoh Corp.

[Pigment Dispersion Liquid 1]

10 g of a carbon black which had a surface area of 230 m²/g and a DBP oil absorption of 70 ml/100 g, and 3.41 g of p-aminobenzoic acid were thoroughly mixed in 72 g of water, and then 1.62 g of nitric acid was added dropwise to this mixture. The mixture was stirred at 70° C. After several minutes, a solution prepared by dissolving 1.07 g of sodium nitrite in 5 g of water was added thereto, and the resulting mixture was further stirred for one hour. The slurry thus obtained was filtered through a Toyo filter paper No. 2 (manufactured by Advantis Technologies, Inc.), and the pigment particles were sufficiently washed with water and dried in an oven at 90° C. Subsequently, water was added to this pigment, and thus a pigment dispersion liquid having a pigment concentration of 10% by weight was prepared.

As described above, a pigment dispersion liquid 1 was obtained, in which an anionically charged self-dispersing type carbon black had a carboxylate group bonded to the surface of the pigment via a phenylene group as represented by the following formula.

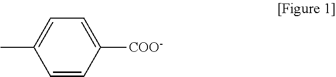

[Pigment Dispersion Liquid 2]

### (Resin-Coated Pigment Dispersion Liquid)

10 g of a carbon black which had a surface area of 230 m²/g and a DBP oil absorption of 70 ml/100 g, 4 g of a benzyl methacrylate/methacrylic acid (=90/10 [mass %]) copolymer, 20 g of methyl ethyl ketone, 4.2 g of 1 N aqueous solution of NaOH, and 100.8 parts of ion-exchanged water were mixed, and the mixture was dispersed for 2 to 6 hours in a bead mill using 0.1-mmφ zirconia beads. Subsequently, methyl ethyl ketone was removed from the dispersion thus obtained at 55° C. under reduced pressure, and a portion of water was further removed. Thus, a pigment dispersion 2 of resin-coated carbon black particles having a carbon black concentration of 10.2% by mass was prepared.

[Preparation of Latex]

### Synthesis Example 1

To 120 g of water, 19.8 g of Latemul ASK (manufactured by Kao Corp.; carboxylate-based emulsifier), 6 g of a 5 mol/L aqueous solution of sodium hydroxide, and 0.3 g of 2,2′-azobis(2-amidinopropane)dihydrochloride were added and uniformly dissolved.

The solution was heated to 70° C., and under a nitrogen gas stream, a monomer mixture of 25.9 g of styrene, 26.3 g of butyl acrylate and 5.1 g of acrylic acid was added to the solution over 2 hours. Thereafter, the mixture was heated for 2 hours at 70° C., and for 3 hours at 80° C. The mixture was cooled to room temperature, and then a 1 mol/L aqueous solution of sodium hydroxide was added thereto while stirring, so that the pH reached approximately 9. Thus, a latex PL-01 was obtained.

The volume average particle size of the latex thus obtained was 115 nm. The solids content of the latex was 33% by mass.

The particle size of the resin particles in the latex was measured by a dynamic light scattering method using a Nanotrac particle size distribution analyzer, UPA-EX150 (manufactured by Nikkiso Co., Ltd.).

[Preparation of Ink Set]

—Preparation of Aqueous Ink—

Next, an aqueous ink having the following composition was prepared using the pigment dispersion liquid 1 and latex PL-1 thus obtained. The pH of this aqueous ink at 25° C. was 8.9.

### <Composition>

| | | |
|---|---|---|
| Pigment dispersion liquid 1 (solids content) | 38.2 | parts |
| Latex PL-01 (solids content) | 8 | parts |
| Glycerin | 15 | parts |
| Diethylene glycol monoethyl ether | 5 | parts |
| Emphos CS131 (Phosphoric acid ester surfactant, | 1 | part |
| containing 6 moles of EO per mole of phosphoric | | |
| acid ester, manufactured by Witco Corp.) | | |
| Orfin E1010 | 1 | part |
| (Acetylene glycol-based surfactant, | | |
| manufactured by Nissin Chemical | | |
| Industry Co., Ltd.) | | |

| | |
|---|---|
| Ion exchanged water | Amount to make the total |
| | amount 100 parts |

—Preparation of Treatment Liquid—

Components of the following composition were mixed, and thus a treatment liquid 1 was prepared.

### <Composition>

| | | |
|---|---|---|
| Vantocil IB (Polyguanidine, manufactured | 4.0 | parts |
| by Avecia Inc.) | | |
| Trimethylolpropane | 10.0 | parts |
| Orfin E1010 | 1.0 | part |
| (Acetylene glycol-based surfactant, manufactured | | |
| by Nissin Chemical Industry Co., Ltd.) | | |
| 2-Ethyl-1,3-hexanediol | 2.0 | parts |
| Sodium dehydroacetate | 0.2 | parts |

| | |
|---|---|
| Ion exchanged water | Amount to make the |
| | total amount 100 parts |

In this manner, an ink set including a black aqueous ink and a treatment liquid 1 was prepared.

—Evaluation of Ink Set—

An inkjet apparatus equipped with a prototype print head (piezo element) having 256 nozzles with a density of 600 dpi, was provided as an inkjet recording apparatus, and the ink set obtained as described above was loaded in the recording apparatus. Occurrence of white streaks was evaluated by the following method. FX-L paper (manufactured by Fuji Xerox Co., Ltd.) was used as the recording medium.

—Evaluation of White Streaks—

The treatment liquid and the aqueous ink thus obtained were ejected in this order from separate heads for 60 minutes on FX-L paper, and then a pressure of 15 kPa was applied thereto for 10 seconds as a maintenance operation. Subsequently, wiping was performed with a clean wiper, FF-390c (manufactured by Kuraray Co., Ltd.), and then ejection was continued for another 5 minutes. After a lapse of 5 minutes, images (5 cm×5 cm) recorded on the FX-L paper were visually observed. The observed images were evaluated by visual inspection according to the following evaluation criteria. The evaluation A, B and C are the level which can be practical applied.

### <Evaluation Criteria>

A: Occurrence of white streaks was not observed.
B: Occurrence of white streaks was observed at two or fewer sites.
C: Occurrence of white streaks was observed at 3 to 5 sites.
D: Occurrence of white streaks was observed at 5 to 10 sites.
E: Occurrence of white streaks was observed at more than 10 sites.

—Evaluation of Scratch Resistance—

(a) A printer head, GELJET GX5000 (a full-line head manufactured by Ricoh Co., Ltd.) was provided, and a storage tank connected to this printer head was refilled with cyan ink. Tokubishi Art Double-Sided N (manufactured by Mitsubishi Paper Mills, Ltd.) was fixed on a stage that was movable in a predetermined linear direction at 500 mm/sec as the recording medium. The treatment liquid (1) obtained as described above was ejected under the conditions of 5 pL per 50 μm², and was dried for 2 seconds at 50° C.

(b) Thereafter, the GELJET GX5000 printer head (a full-line head manufactured by Ricoh Co., Ltd.) was fixed and arranged such that the line head direction (main scanning direction) along which nozzles were aligned was tilted by 75.7° relative to the direction orthogonal with the moving direction of the stage (sub-scanning direction), and while the recording medium was moved at a constant speed in the sub-scanning direction, ink was ejected by a line system under the ejection conditions of an ink droplet amount of 3.5 pL, an ejection frequency of 24 kHz, and a resolution of 1200 dpi×600 dpi. Thus solid images were printed, and thus an evaluation sample was obtained. After the printing, the paper was dried for 5 seconds at 60° C.

Unprinted Tokubishi Art Double-Sided N (manufactured by Mitsubishi Paper Mills, Ltd.) was cut to a size of 10 mm×50 mm and was wound around a paperweight (weight 470 g, size 15 mm×30 mm×120 mm) (the area of contact between the unprinted Tokubishi Art Double-Sided N and the evaluation sample was 150 mm²). The evaluation sample produced as described above was rubbed 3 times in a reciprocating manner (corresponding to a load of 260 kg/m²). The printed surface after rubbing was observed by the naked eye, and the sample was evaluated according to the following evaluation criteria.

<Evaluation Criteria>
A: Peeling of image on the printed surface not recognized at all.
B: Slight peeling of image on the printed surface was recognized, but at a level acceptable in terms of practical application.
C: Peeling of image on the printed surface was recognized at a level unacceptable in terms of practical application.

### Examples 2 to 4, and Comparative Example 1

Aqueous ink compositions were prepared in the same manner as in Example 1, except that the amount of addition of the phosphoric acid ester (surfactant) in the aqueous ink composition was changed as indicated in Table 1, and ink sets were obtained using the aqueous ink compositions. Subsequently, evaluations were carried out in the same manner as in Example 1. The results for the measurements and evaluations are shown in the following Table 1.

### Example 5

An ink set was obtained in the same manner as in Example 1, except that the pigment dispersion liquid 3 was used, which was prepared in the same manner by changing the carbon black used in the “Preparation of pigment dispersion liquid 1” of Example 1 to magenta pigment PR122. Subsequently, an evaluation was carried out in the same manner as in Example 1. The results for the measurement and evaluations are shown in the following Table 1.

### Example 6

An aqueous ink composition was prepared in the same manner as in Example 1, except that the type of the phosphoric acid ester (surfactant) in the aqueous ink composition was changed to sodium monododecyl phosphate (manufactured by Tokyo Chemical Industry Co., Ltd.), and an ink set was obtained using this aqueous ink composition. Subsequently, evaluations were carried out in the same manner as in Example 1. The results for the measurements and evaluations are shown in the following Table 1.

### Comparative Example 2

Aqueous ink compositions were prepared in the same manner as in Example 5, except that the amount of addition of the phosphoric acid ester (surfactant) in the aqueous ink composition was changed as indicated in Table 1, and ink sets were obtained using the aqueous ink compositions. Subsequently, evaluations were carried out in the same manner as in Example 5. The results for the measurements and evaluations are shown in the following Table 1.

### Comparative Example 3

An ink set was obtained in the same manner as in Example 1, except that the carbon black used in the “Pigment dispersion liquid 1” of Example 1 was changed to Cabojet-200 having a sulfonic acid group at the surface, as the carbon black self-dispersing pigment. Subsequently, an evaluation was carried out in the same manner as in Example 1. The results for the measurement and evaluations are shown in the following Table 1.

### Comparative Example 4

An ink set was obtained in the same manner as in Example 1, except that the “pigment dispersion liquid 2” was used instead of the “pigment dispersion liquid 1” of Example 1. Subsequently, an evaluation was carried out in the same manner as in Example 1. The results for the measurement and evaluations are shown in the following Table 1.

TABLE 1

| | Ink | | | |
|---|---|---|---|---|
| | | Amount | | Eval- |
| | | of | Eval- | uation |
| | | phos- | uation | of |
| | | phoric | of | scratch |
| | | acid ester | white | resis- |
| | Pigment dispersion liquid | (wt %) | streaks | tance |
| Example 1 | Pigment dispersion liquid 1 | 1.0 | A | B |
| | (carbon black) | | | |
| Example 2 | Pigment dispersion liquid 1 | 0.5 | B | B |
| | (carbon black) | | | |
| Example 3 | Pigment dispersion liquid 1 | 2.0 | A | B |
| | (carbon black) | | | |
| Example 4 | Pigment dispersion liquid 1 | 0.1 | C | B |
| | (carbon black) | | | |
| Example 5 | Pigment dispersion liquid 3 | 1.0 | B | B |
| | (PR122) | | | |
| Example 6 | Pigment dispersion liquid 1 | 1.0 | C | B |
| | (carbon black) | | | |
| Comparative | Pigment dispersion liquid 1 | 0.0 | D | B |
| Example 1 | (carbon black) | | | |
| Comparative | Pigment dispersion liquid 3 | 0.0 | E | B |
| Example 2 | (PR122) | | | |
| Comparative | Cabojet 200 (carbon black) | 1.0 | B | C |
| Example 3 | | | | |
| Comparative | Pigment dispersion liquid 2 | 1.0 | D | B |
| Example 4 | (carbon black, | | | |
| | resin-coated type) | | | |

As shown in Table 1 above, in the Examples, failure in the ejection directionality caused by the adhesion of aggregates to the head was prevented, and the occurrence of white streak defects in the recorded images could be suppressed. Furthermore, the mist generated by deposits produced by the two liquids was readily removable, and thus alleviation and facilitation in the maintenance properties were promoted.

On the contrary, in the Comparative Examples, adhesion of aggregates to the head occurred markedly, so that the failure in the ejection directionality of ejected ink could not be prevented, and the occurrence of white streak defects could not be suppressed.

In the Examples described above, the instances of preparing black and magenta aqueous ink compositions as the aqueous ink composition were mainly described, but aqueous ink compositions of various colors, such as an aqueous cyan ink composition and an aqueous yellow ink composition can be obtained in the same manner as described above, by modifying the type (color) of the pigment used in the aqueous black ink composition. Furthermore, when aqueous ink compositions of two or more colors are loaded in an inkjet apparatus, multicolor images can be recorded in the same manner as described above, and the same results and effects can be obtained.

What is claimed is:

1. An ink set comprising an aqueous ink composition which contains a self-dispersing pigment having a carboxyl group at the surface, a water-soluble organic solvent, a phosphoric acid ester, and water; and a treatment liquid which contains a cationic polymer and which agglomerates the self-dispersing pigment when brought into contact with the aqueous ink composition.

2. The ink set according to claim 1, wherein the phosphoric acid ester is anionic and has 4 or more moles of ethylene oxide per mole of the ester molecule.

3. The ink set according to claim 1, wherein the cationic polymer includes at least one polyguanidine.

4. The ink set according to claims 1, wherein the aqueous ink composition further contains resin particles.

5. The ink set according to claim 1, wherein the self-dispersing pigment includes a magenta pigment.

6. The ink set according to claim 1, wherein the aqueous ink composition includes at least one selected from a black ink composition, a cyan ink composition, a magenta ink composition, and a yellow ink composition.

7. An image forming method by using an ink set comprising an aqueous ink composition which contains a self-dispersing pigment having a carboxyl group at the surface, a water-soluble organic solvent, a phosphoric acid ester, and water; and a treatment liquid which contains a cationic polymer and which agglomerates the self-dispersing pigment when brought into contact with the aqueous ink composition, the method comprising an ink applying step of applying the aqueous ink composition in the ink set on a recording medium by an inkjet method; and a treatment liquid applying step of applying the treatment liquid in the ink set on the recording medium.

8. The image forming method according to claim 7, wherein an inkjet apparatus having an inkjet head ejecting the aqueous ink composition and an inkjet head ejecting the treatment liquid is used to form an image on the recording medium.
